(19) United States
(12) Patent Application Publication
(10) Pub. No.: US 2010/0274593 A1
(43) Pub. Date: Oct. 28, 2010

(54) Debt disappearance protection

(76) Inventor: Darrell Lee Dreher, Columbus, OH (US)

Correspondence Address: Darrell L. Dreher;2750 Huntington Center, 41 South High Street, Columbus, OH, 43215, US

(21) Appl. No.: 12/386,861

(22) Filed: Apr. 24, 2009

(51) Int. Cl. G06Q 40/00

(52) U.S. Cl. 705/4; 705/35

(57) ABSTRACT

A method of offering and providing debt disappearance protection to a customer, comprising the steps of (i) marketing debt disappearance protection to customers through various marketing channels; (ii) selling a debt disappearance contract to a customer; and (iii), upon the happening of certain triggering events, acquiring a specific dollar amount of debt, acquiring certain specified debts, in whole or in part, or acquiring the customer's debt, in whole or in part, in an amount equal to the customer's required periodic payments as they come due. The debt disappearance company (“DDC”) acquires the customer's debt pursuant to the debt disappearance contract and agrees never to (i) attempt to collect the consumer's debt that it has acquired, (ii) report the consumer's debt that it has acquired to credit bureaus, (iii) sell the customer's debt that it has acquired or (iv) forgive the customer's debt that it has acquired.

### METHOD AN SYSTEM FOR OFFERING AND PROVIDING DEBT

DISAPPERANCE PROTECTION TO A CUSTOMER

### BACKGROUND OF THE INVENTION

Over the last few decades, the availability of credit has exploded. More people have access to more credit in more forms than ever before. The same period has seen an equally dramatic expansion in the complexity and variety of credit products. Some of the more risk-adverse borrowers seek out debt protection products, which can suspend, cancel, or make required payments on a debt when a borrower dies or becomes disabled or unemployed. A borrower currently has two options for debt protection products. In the first option, the debtor enters into a contract with his or her creditor whereby the creditor agrees to cancel or temporarily suspend a debt upon the occurrence of a triggering event (e.g., death, disability, unemployment, or other identified event potentially affecting the customer's ability to pay his or her debts as they become due). In the second option, the debtor may purchase an insurance product from an independent third party that operates similarly to a debt protection product offered by the creditor in that it pays the borrower (or the borrower's designee) in the event of loss, but the provider of the insurance ordinarily must be licensed to sell such a product.

If a borrower wants to ensure that all of his or her debts are covered if he or she dies or becomes unemployed or disabled, a borrower must either enter into debt protection agreements with all of his or her individual creditors, assuming that each creditor even offers such a product, or contract with an independent insurance provider to purchase the same. Each creditor is limited to offering a debt protection product on only the debt owed to that specific creditor, unless it is licensed to sell such insurance. The need for competition in the debt protection marketplace is apparent.

Credit-related debts are not the sole source of concern for consumers and others, however. With the expansion of credit reporting to include non-credit related debts, risk adverse persons may desire an expansion of protection options to include such non-credit related debts; needs not currently or consistently met by existing debt protection products.

A borrower should be afforded alternative options of purchasing a product that will protect all of his or her debts, if the borrower so chooses.

### SUMMARY OF THE INVENTION

The present invention provides a method and system for offering and providing debt disappearance protection to a customer. It is an object of the present invention to allow a customer to purchase debt disappearance protection for as many or as few debts as the customer chooses by entering into a debt disappearance contract. The customer is permitted to purchase (i) a specific dollar amount of debt disappearance protection, to be applied as the customer chooses upon the happening of a triggering event, (ii) debt disappearance protection for certain debts, in whole or in part, specified by the customer upon entering into the debt disappearance contract or (iii) an amount equal to the customer's required periodic payments, in whole or in part, as they become due.

It is an object of the present invention to allow the customer to pay either (i) a lump sum or (ii) periodic payments for the debt disappearance protection.

It is an object of the present invention for the DDC, upon the happening of certain triggering events (e.g., death, disability, unemployment, or other identified event potentially affecting the customer's ability to pay his or her debts as they become due) to issue checks or use another payment method to acquire either (i) debts specified by the customer at the time of the triggering event, where the customer has purchased debt disappearance protection for a specific dollar amount of outstanding debt to be applied at the customer's discretion, or (ii) the specific debts for which the customer purchased debt disappearance protection when he or she entered into the debt disappearance contract.

It is an object of the present invention that, when the DDC acquires the customer's debt, the DDC is subrogated, by law and pursuant to the debt disappearance contract, to the rights of the original creditor. The debt disappearance contract will provide that, upon acquiring the debt, the DDC acquires all of the former creditor's right, title and interest in and to the purchased debt. The DDC records the acquired debt as an account receivable and permanently lists the debt as an acquired asset on its books.

It is an object of the present invention to make the customer's debt effectively “disappear” by the DDC agreeing in the debt disappearance contract that, after the DDC acquires a customer's debt, the DDC will never (i) attempt to collect the customer's debt, (ii) report the customer's debt to a credit bureau, (iii) sell the customer's debt or (iv) forgive the customer's debt.

### BRIEF DESCRIPTION OF THE DRAWINGS

FIG. 1 is a diagram of the methods of soliciting the customer for the present invention.

FIG. 2 is a diagram that illustrates the operation and process of the present invention.

### DETAILED DESCRIPTION

The present invention will now be described more fully hereinafter, an example of which is illustrated in the accompanying drawings. This invention, however, may be embodied in many different forms and is not limited to the embodiments described herein.

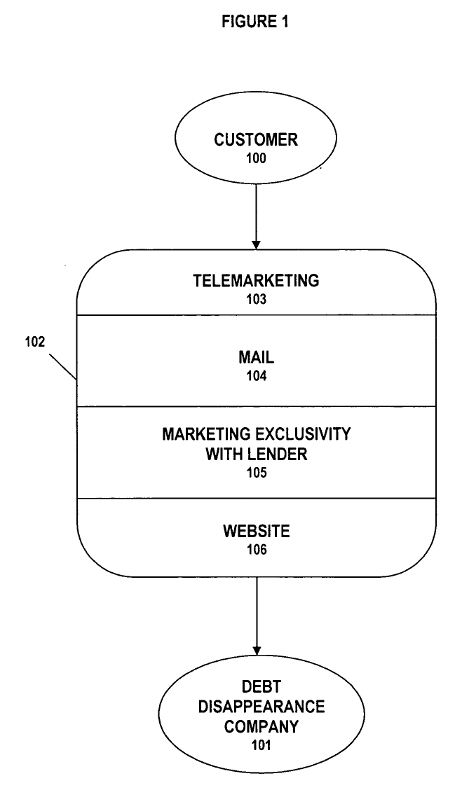

FIG. 1 shows an overview of the methods of soliciting the customer 100 for the present invention. The DDC 101 can be connected with the customer 100 through various marketing channels 102. The customer 100 may be contacted through a telemarketing 103 program, whereby a licensed telemarketer calls the customer 100 to solicit participation in the present invention. The customer 100 may also be mailed the marketing material for the present invention 104. The DDC 101 may also enter into marketing exclusivity agreements with various creditors 105, whereby the present invention will be marketed to a new customer 100 at the time that the creditor agrees to extend credit to the customer 100 or to existing customers on already-extended credit. Lastly, the present invention may be marketed to the customer 100 through a DDC 101 website 106, which may be brought to the customer's 100 attention through search optimization techniques or internet advertisements. The customer 100 will have the option of contacting the DDC 101 by mail, telephone, internet or other means to apply for the present invention.

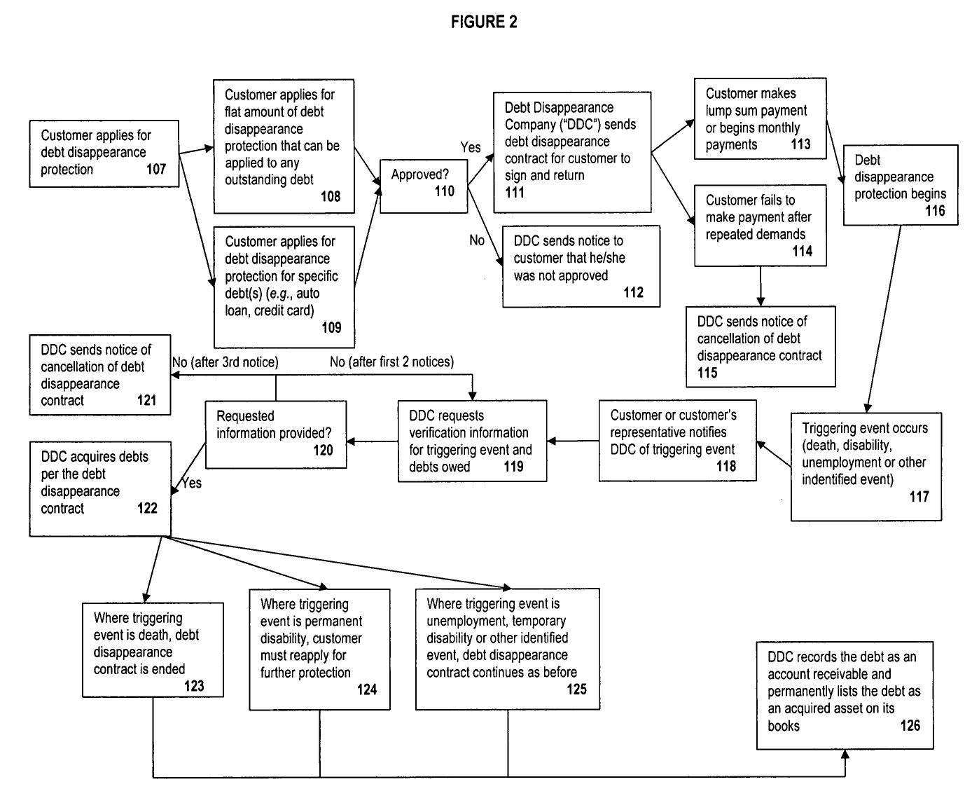

FIG. 2 is a flow chart that illustrates the operation of the present invention. In an embodiment of the present invention, the customer 100 applies for the present invention 107 via one of the marketing channels described above. The customer 100 can choose to apply for a specific dollar amount of debt disappearance protection 108 to be determined upon the happening of a triggering event, or to apply for debt disappearance protection for specific debts 109 (e.g., mortgage, automobile loan, credit card, utility bill etc.). No credit checks will be performed by the DDC 101 upon application, but the DDC 101 may request verification of employment or the specific debts that the customer 100 is seeking to enroll in the present invention. If the customer 100 properly completes the application and is approved, the DDC 101 will send the materials for the present invention to the customer 100 for the customer 100 to sign and return 111. If the customers' 100 application is incomplete, the DDC 101 will request the missing information from the customer 100. If the customer 100 does not complete the application or the DDC 101 decides not to contract for debt disappearance protection with the customer 100, the DDC 101 will send a letter to the customer 100, informing the customer 100 that his or her application was not approved.

In an embodiment of the present invention, the customer 100 is required to either (i) make a lump sum payment or (ii) agree to make periodic payments and then actually make the first required periodic payment for the debt disappearance protection to begin 116. If the customer 100 chooses to make periodic payments, the customer 100 will only be entitled to the debt disappearance protection for the term for which he or she has paid. If the customer 100 fails to make the lump sum or first periodic payment upon approval 114, the customer 100 is sent a notice that the debt disappearance contract has been cancelled 115. For a customer 100 who chooses the periodic payment option, the customer 100 has multiple options for making payments; the customer 100 may make payments by various means, including, but not limited to, (i) check, (ii) credit card or (iii) ACH withdrawal from a checking or deposit account, and the customer 100 can choose to set up automatic payments at his or her discretion.

In an embodiment of the present invention, upon the occurrence of a triggering event 117 (e.g., death, disability, unemployment, or other identified event potentially affecting the customer's ability to pay his or her debts as they become due), the customer 100 (or his or her representative) is required to notify the DDC 101 of the triggering event 118. When the customer 100 notifies the DDC 101 of the triggering event, the DDC 101 may require the customer 100 to provide verification of the triggering event 119. The DDC 101 may also request that the customer 100 provide verification of the debts that the customer 100 is seeking to have acquired pursuant to the present invention 119. If the DDC 101 requests and the customer 100 provides the requested verification 120, the DDC 101 will then issue checks or use another payment method to acquire either (i) the customer's 100 debts that the customer 100 specifies at the time of the triggering event (where the customer 100 has purchased debt disappearance protection for a specific dollar amount of outstanding debts 108) or (ii) the specific debts for which the customer 100 has purchased debt disappearance protection (where the customer 100 has purchased debt disappearance only for certain specified debts 109) 122. If the customer 100 refuses or fails to provide the requested verifying information after repeated requests, the DDC 101 may send the customer 100 notice of cancellation of the debt disappearance contract 121 and will not issue checks to acquire the customer's 100 debts.

In an embodiment of the present invention, when the DDC 101 issues a check or uses another payment method to acquire the customer's 100 debt, the DDC 101 is, by law, and pursuant to the debt disappearance contract, subrogated to the rights of the customer's 100 original creditor. The DDC 101 therefore records the debt as an account receivable and permanently lists it as an acquired asset on its books 126. However, the DDC's 101 contract with the customer 100 provides that the DDC 101 will never (i) attempt to collect the customer's 100 debt that it has acquired, (ii) report the customer's 100 debt that it has acquired to credit bureaus, (iii) sell the customer's 100 debt that it has acquired or (iv) forgive the customer's 100 debt that it has acquired. The customer's 100 debt is not extinguished, but, as far as the customer 100 is concerned, the debt has disappeared.

In an embodiment of the present invention, where the triggering event 117 is the customer's 100 death, the debt disappearance contract is ended after the DDC 101 issues a check or uses another payment method to acquire the customer's 100 debt 123. Where the triggering event 117 is permanent disability, the debt disappearance contract is ended after the DDC 101 issues a check or uses another payment method to acquire the customer's 100 debt, but the customer 100 is permitted to re-apply for coverage 124. Where the triggering event is unemployment, temporary disability or any other identified event potentially affecting the customer's ability to pay his or her debts as they become due, the DDC 101 only acquires the customer's 100 debt in an amount equal to the customer's 100 periodic payments when they become due; the entire debts are not acquired. After (i) the customer 100 notifies the DDC 101 that the temporary disability, unemployment or other circumstance has ended, (ii) the maximum time period for debt disappearance payments for temporary disability, unemployment or other identified circumstance has expired, or (iii) the maximum amount of the debt disappearance contract has been reached, the debt disappearance contract continues as before 125.

### CONCLUSION

The embodiments illustrated and discussed above are intended to inform only those who are skilled in one art the best possible way to make and use the invention. Numerous modifications and adaptations of the present invention will be readily apparent to those skilled in the art without departing from the purpose and scope of the present invention. Thus, the present invention is limited only by the following claims:

What is claimed is:

1) A method of offering and providing debt disappearance protection to a customer, comprising the steps of:
Marketing debt disappearance protection to customers through various marketing channels;
Selling a debt disappearance contract to a customer; and
Upon the happening of certain triggering events, acquiring (i) a specific dollar amount of debt, (ii) certain specified debts, in whole or in part, or (iii) the customer's debt, in whole or in part, in an amount equal to the customer's required periodic payments as they come due.

2) The method of claim 1, whereby the customer has the option of purchasing debt disappearance protection for either (i) a specific dollar amount of debt, to be applied at the customer's discretion at the time of the triggering event, or (ii) certain debts specified by the customer at the time of entering into the debt disappearance contract.

3) The method of claim 1, whereby on the happening of a triggered event, the DDC issues checks or uses another payment method to acquire (i) debts specified by the customer at the time of the triggering event, where the customer has purchased a specific dollar amount of debt disappearance protection or (ii) specific debts for which the consumer purchased debt disappearance protection at the time of entering into the debt disappearance contract.

4) The method of claim 1 whereby the DDC issues a check or uses another payment method to acquire the customer's debt, and the DDC is therefore, by law and pursuant to the debt disappearance contract, subrogated to the rights of the original creditor.

5) The method of claim 1, whereby the DDC records the customer's debt as an account receivable and permanently lists the debt as an acquired asset on its books, but agrees never to (i) attempt to collect the consumer's debt that it has acquired, (ii) report the consumer's debt that it has acquired to credit bureaus, (iii) sell the customer's debt that it has acquired or (iv) forgive the customer's debt that it has acquired.
